(19) United States
(12) Patent Application Publication
(10) Pub. No.: US 2025/0363966 A1
(43) Pub. Date: Nov. 27, 2025

(54) DISPLAY DEVICE, MULTI-DISPLAY SYSTEM, AND DISPLAY CONTROL METHOD

(71) Applicant: Sharp NEC Display Solutions, Ltd., Tokyo (JP)

(72) Inventor: Junya YAMAZAKI, Tokyo (JP)

(21) Appl. No.: 19/287,119

(22) Filed: Jul. 31, 2025

Related U.S. Application Data
(63) Continuation of application No. PCT/JP2023/010662, filed on Mar. 17, 2023.

(51) Int. Cl. G09G 5/12; G09G 5/18

(52) U.S. Cl. CPC G09G 5/12; G09G 5/18; G09G 2300/026; G09G 2310/08; G09G 2360/04

(57) ABSTRACT

A video input terminal inputs a video signal. A video output terminal outputs the video signal input to the video input terminal. A communication terminal performs one-to-one communication with each of a plurality of display devices. A communication controller notifies each of the plurality of display devices of a control command including control information for issuing an instruction to execute a specific process by switching a destination of communication via the communication terminal and additional information indicating a waiting time before a process corresponding to the control information is executed.

### TECHNICAL FIELD

The present invention relates to a display device, a multi-display system, and a display control method.

### BACKGROUND ART

There is a multi-display system using a plurality of display devices to display a single display screen (see, for example, Patent Document 1). In the multi-display system, the plurality of display devices are arranged adjacent to each other in vertical and horizontal directions, the respective display devices are connected in a daisy chain using, for example, a high-definition multimedia interface (HDMI (registered trademark)) cable or the like, and a video signal is supplied to each display device.

Here, the respective display devices receive a video signal in the order in which they are connected in the daisy chain and perform a process based on the received video signal. For this reason, because a timing when the video signal is received differs according to the display device, a timing when a process based on the video signal is performed may deviate and a video viewed as a single display screen of a multi-display may be distorted. For example, a timing when the video is muted or unmuted deviates according to each display device and only a part of the video on the multi-display is erased or displayed, such that the video may be distorted. To avoid this problem, Patent Document 1 discloses technology in which the respective display devices are synchronized with each other to control a multi-display video.

### CITATION LIST

### Patent Document

Patent Document 1: Japanese Unexamined Patent Application, First Publication No. 2017-037127

### SUMMARY OF INVENTION

### Technical Problem

However, Patent Document 1 is based on the premise that one display device (master device) controls a plurality of display devices (slave devices) simultaneously using a broadcast command, such that video control timings in the respective display devices are synchronized with each other.

In a multi-display system, from a relationship of software resource limitations or the like, a method that does not use simultaneous control using a broadcast command, i.e., “one-to-many communication,” may be adopted. In this case, the master device must perform “one-to-one communication” with each of the plurality of slave devices. When “one-to-one communication” is performed, the technology of Patent Document 1 cannot be applied. Thus, there is a problem that the video control timing deviates and a video displayed by the multi-display is distorted.

In consideration of the above-mentioned problems, an objective of the present invention is to provide a display device, a multi-display system, and a display control method for enabling control execution timings in respective display devices to be synchronized with each other in a multi-display system in which the display devices transmit and receive control signals on a one-to-one basis.

### Solution to Problem

According to an aspect of the present invention, there is provided a display device including: a video input terminal configured to input a video signal; a video output terminal configured to output the video signal input to the video input terminal; a communication terminal configured to perform one-to-one communication with each of a plurality of display devices; and a communication controller configured to notify each of the plurality of display devices of a control command including control information for issuing an instruction to execute a specific process by switching a destination of communication via the communication terminal and additional information indicating a waiting time before a process corresponding to the control information is executed.

According to an aspect of the present invention, there is provided a display device including: a video input terminal configured to input a video signal; a video output terminal configured to output the video signal input to the video input terminal; a communication terminal configured to perform one-to-one communication with another display device; and a command execution controller configured to receive a control command via the communication terminal and execute a process corresponding to control information in the control command when a waiting time indicated in additional information in the control command has elapsed on the basis of the received control command, the control command including the control information for issuing an instruction to execute a specific process and the additional information indicating the waiting time before a process corresponding to the control information is executed.

Moreover, according to an aspect of the present invention, there is provided a multi-display system including a first display device and a plurality of second display devices, wherein the first display device includes a video input terminal configured to input a video signal; a video output terminal configured to output the video signal input to the video input terminal; a communication terminal configured to perform one-to-one communication with each of the plurality of second display devices; and a communication controller configured to notify each of the plurality of second display devices of a control command including control information for issuing an instruction to execute a specific process by switching a destination of communication via the communication terminal and additional information indicating a waiting time before a process corresponding to the control information is executed, and wherein each of the plurality of second display devices includes a video input terminal configured to input a video signal; a video output terminal configured to output the video signal input to the video input terminal; a communication terminal configured to perform one-to-one communication with the first display device; and a command execution controller configured to execute a process corresponding to the control information in the control command when the waiting time indicated in the additional information in the control command has elapsed on the basis of the control command received via the communication terminal.

Moreover, according to an aspect of the present invention, there is provided a display control method, which is performed by a display device including a video input terminal configured to input a video signal, a video output terminal configured to output the video signal input to the video input terminal, and a communication terminal configured to perform one-to-one communication with each of a plurality of display devices, the display control method including: notifying, by a communication controller, each of the plurality of display devices of a control command including control 5 information for issuing an instruction to execute a specific process by switching a destination of communication via the communication terminal and additional information indicating a waiting time before a process corresponding to the control information is executed.

Moreover, according to an aspect of the present invention, there is provided a display control method, which is performed by a display device including a video input terminal configured to input a video signal, a video output terminal configured to output the video signal input to the video input terminal, and a communication terminal configured to perform one-to-one communication with another display device, the display control method including: receiving, by a command execution controller, a control command via the communication terminal and executing a process corresponding to control information in the control command when a waiting time indicated in additional information in the control command has elapsed on the basis of the received control command, the control command including the control information for issuing an instruction to execute a specific process and the additional information indicating the waiting time before a process corresponding to the control information is executed.

### Advantageous Effects of Invention

According to the present invention, control execution timings of respective 25 display devices can be synchronized with each other in a multi-display system in which the display devices transmit and receive control signals on a one-to-one basis.

### BRIEF DESCRIPTION OF DRAWINGS

FIG. 1 A diagram showing an example of a configuration of a multi-display system in an embodiment.

FIG. 2 A block diagram showing an example of a configuration of a display device in the embodiment.

FIG. 3 An explanatory diagram of a process performed by the display device in the embodiment.

FIG. 4 A sequence diagram showing a flow of a process performed by the multi-display system in the embodiment.

FIG. 5 A sequence diagram showing the flow of the process performed by the multi-display system in the embodiment.

FIG. 6 A diagram showing an example of information set in the display device in the embodiment.

FIG. 7 A diagram showing an example of information set in the display device in the embodiment.

FIG. 8 A diagram showing an example of information set in the display device in the embodiment.

FIG. 9 A sequence diagram showing a flow of a process performed by the multi-display system in the embodiment.

FIG. 10 An explanatory diagram of the multi-display system in the embodiment.

FIG. 11 An explanatory diagram of the multi-display system in the embodiment.

FIG. 12 An explanatory diagram of the multi-display system in the embodiment.

FIG. 13 A block diagram showing a basic configuration of the multi-display system in the embodiment.

### DESCRIPTION OF EMBODIMENTS

Hereinafter, an embodiment of the present invention will be described.

### EXAMPLES

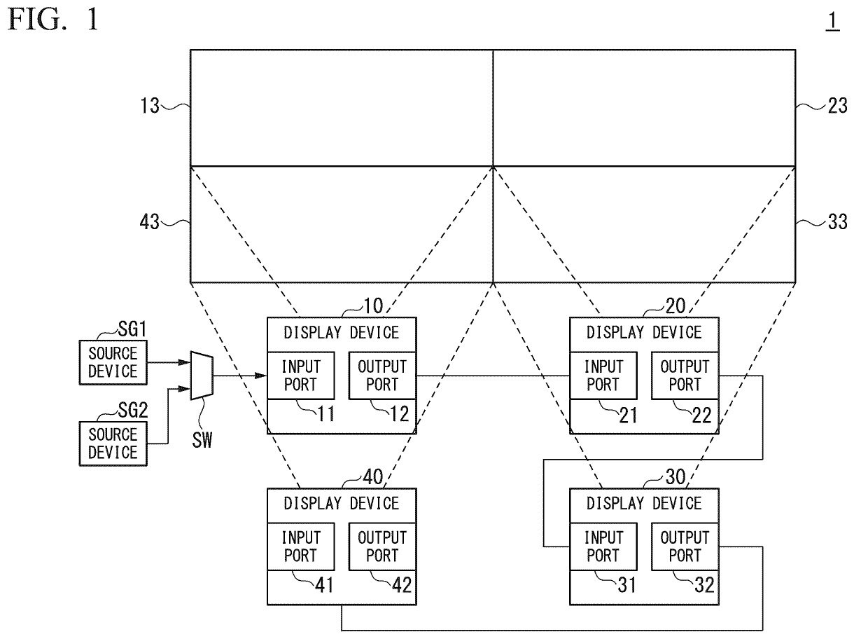

FIG. 1 is a diagram showing an example of a configuration of a multi-display system in the embodiment. A multi-display system 1 includes a plurality of display devices. For example, the multi-display system 1 includes four display devices (a display device 10, a display device 20, a display device 30, and a display device 40). For example, the multi-display system 1 includes the plurality of display devices arranged adjacent to each other in vertical and horizontal directions and supplies a video signal to each display device. Thereby, a single display screen can be displayed using display screens of the respective display devices.

For example, in the multi-display system 1, as shown in the example of this drawing, the four display devices are connected in a daisy chain in the order of the display device 10, the display device 20, the display device 30, and the display device 40 using an HDMI (registered trademark) cable. Moreover, video and control signals and the like are transmitted via the HDMI (registered trademark) cable on the basis of an HDBaseT standard.

Although an example in which four display devices are daisy-chained will be described in the present embodiment, the present invention is not limited thereto. In the multi-display system 1, it is only necessary for at least two display devices to be connected in a daisy chain. Moreover, when there is no need to distinguish between the display devices 10, 20, 30, and 40 in the description of the embodiment, they may simply be referred to as a “display device.”

Source devices SG (source devices SG1 and SG2) are connected to the display device 10 at the head of the daisy chain connection via a cable and a switch SW. The source device SG is a personal computer, a video output device, or the like, and outputs a video signal. The video signal from either one of the source devices SG1 and SG2 is input to the display device 10 via the switch SW.

The display device has an input port that inputs a video signal and an output port that outputs the video signal input to the input port to a subsequent-stage display device. For example, the display device 10 has an input port 11 that inputs a video signal and an output port 12 that outputs the video signal input to the input port 11 to the subsequent-stage display device 20. The display device 20 has an input port 21 that inputs a video signal and an output port 22 that outputs the video signal input to the input port 21 to the subsequent-stage display device 30.

The source devices SG1 and SG2 are connected to the input port 11 of the display device 10, which is at the head of the daisy chain connection, via a cable. The source device SG is a personal computer, a video output device, or the like and outputs a video signal to the display device 10.

The display device has a display unit including a display such as a liquid crystal display or an organic electroluminescence (EL) display and displays the video signal input to the display device on the display unit. For example, the display device 10 has a display unit 13 including a display such as a liquid crystal display and displays the video signal input to the display device 10 on the display unit 13. The display units of the plurality of display devices (the display unit 13, a display unit 23, a display unit 33, and a display unit 43) are arranged adjacent to each other in the vertical and horizontal directions, and each display device displays the input video signal, thereby displaying a single display screen.

Among the plurality of display devices connected in the daisy chain, the first display device 10 functions as a display device that is a master (hereinafter also referred to as a “master display device”). On the other hand, among the plurality of display devices connected in the daisy chain, the display devices (the display devices 20, 30, and 40) other than the master display device function as display devices that are slaves (hereinafter also referred to as “slave display devices”). The master display device controls the slave display devices. Specifically, the master display device instructs the slave display devices to perform a video muting operation for erasing the video display and a video unmuting operation.

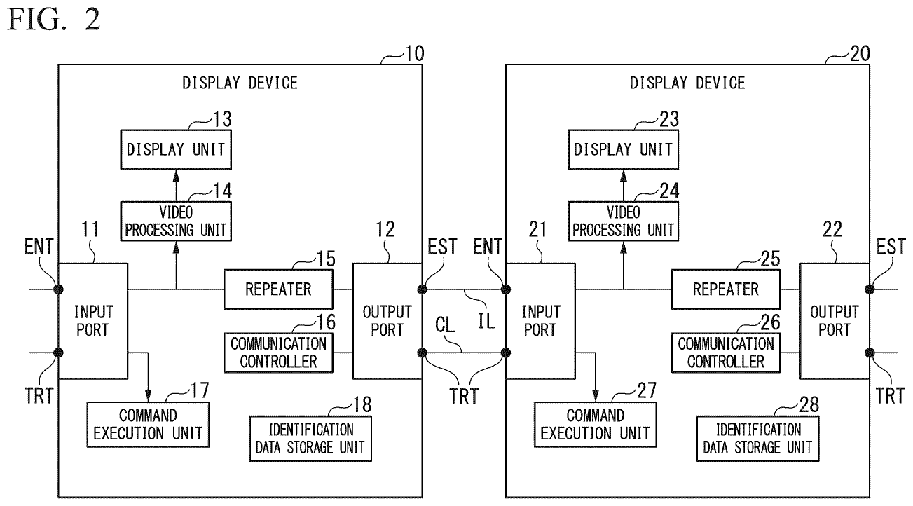

FIG. 2 is a block diagram showing an example of a configuration of the display device in the embodiment. In the example of this drawing, the display device 10 at the head of the daisy chain connection and the display device 20 connected to the subsequent stage among the four display devices shown in FIG. 1 are shown and the display devices 30 and 40 are omitted from the illustration.

The display device 10 includes the input port 11, the output port 12, the display unit 13, a video processing unit 14, a repeater 15, a communication controller 16, and a command execution unit 17.

The input port 11 is an input port that inputs a video signal. The output port 12 is an output port that outputs the video signal input to the input port 11. A video input terminal ENT and a communication terminal TRT are provided in the input port 11. A video output terminal EST and a communication terminal TRT are provided in the output port 12.

The HDMI (registered trademark) cable connected to the input port 11 and the output port 12 has a video signal line IL through which a video signal is transmitted and a control signal line CL through which a signal (a control command) other than the video signal is transmitted. The video signal line IL connects the video output terminal EST of the display device 10 to the video input terminal ENT of the subsequent-stage display device 20. Thereby, the video signal input to the input port 11 of the display device 10 is input to the display device 20 via the output port 12. The control signal line CL connects the communication terminal TRT provided in the output port 12 of the display device 10 to the communication terminal TRT provided in the input port 11 of the subsequent-stage display device 20. Thereby, the control command output from the output port 12 of the display device 10 is input to the display device 20.

Through the control signal line CL, for example, control commands are transmitted and received using consumer electronics control (CEC). Thereby, the display devices connected by the cable can operate each other. The control commands transmitted and received via the control signal line CL include, for example, a command for issuing an instruction to perform a video muting operation for erasing the video display and a command for issuing an instruction to perform a video unmuting operation.

The display unit 13 is a display unit including a display such as a liquid crystal display or an organic EL display and displays the video signal input to the display device 10. The video processing unit 14 processes the video signal input to the input port 11 and outputs the processed video signal to the display unit 13. The repeater 15 is a repeater for outputting the video signal input to the input port 11 to the output port 12.

The communication controller 16 transmits and receives a control command via the control signal line CL. The communication controller 16 designates physical addresses of two display devices of a source and a destination in a notification for providing the control command and transmits the control command. Here, the physical address of the display device is stored, for example, in an identification data storage unit 18. The command execution unit 17, for example, outputs a control command including a physical address of its own device that is a transmission source, a physical address of a destination display device, a command identification number, an argument according to the command, and the like to a communication terminal TRT provided in the output port 12. Thereby, the control command is transmitted to the destination display device.

The command execution unit 17 executes a process according to the control command provided in the notification via the control signal line CL. For example, when a notification of a command for issuing a video muting instruction has been provided, the command execution unit 17 erases the video displayed on the display unit 13. After the process corresponding to the control command is executed, the command execution unit 17 returns an ACK (response) to a display device of a transmission source from which the notification of the control command has been provided.

The identification data storage unit 18 is an internal memory that stores extended display identification data (EDID) of its own device. In the EDID, the physical address of each of the display devices connected in the daisy chain is stored.

Because the configurations of the display device 20, the display device 30, and the display device 40 are similar to that of the display device 10, description thereof will be omitted.

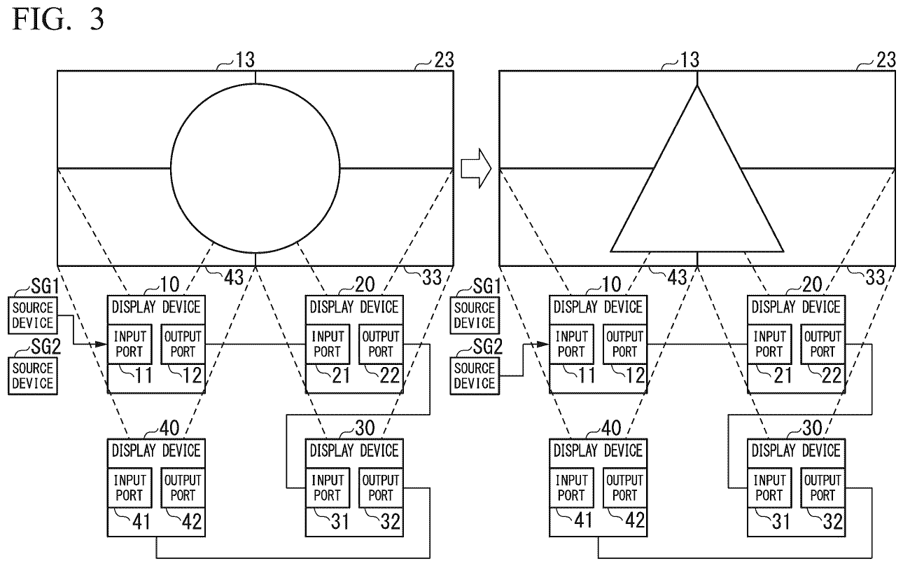

FIG. 3 is an explanatory diagram of a process performed by the display device in the embodiment. In FIG. 3, a state in which a video signal input to the video input terminal ENT of the display device 10 is switched is schematically shown. The left side of FIG. 3 shows a state in which a video output from the source device SG1 and a video in which a circular image is shown are displayed. On the other hand, the right side of FIG. 3 shows a state in which a video output from the source device SG2 and a video on which a triangular image is shown are displayed.

As shown in the example of this drawing, when the video has been switched, the master display device instructs all slave devices to perform a video muting operation by transmitting a control command to all the slave devices and also performs a video muting operation on its own device if it is detected that the video has been switched. Each display device detects a state of the post-switching video, for example, a state such as a high-bandwidth digital content production (HDCP) authentication operation state, a synchronization signal frequency, a pixel frequency, or a synchronization signal polarity. Also, each display device performs various types of settings according to the detected video state so that a post-switching video is displayed correctly. Subsequently, the master display device issues a video unmuting instruction by transmitting a control command to all the slave devices and also executes the video unmuting operation on the device. Thereby, the post-switching video is displayed.

Here, in the present embodiment, broadcast (simultaneous transmission) cannot be set as the destination of the control command. In other words, it does not support broadcast commands to be communicated from one display device to a plurality of display devices at the same time.

For this reason, for example, when the display device 10 tries to instruct each of the display devices 20, 30, and 40 to perform the video muting operation, it is necessary to iteratively perform one-to-one communication with each of the display devices 20, 30, and 40.

For example, the display device 10 first sets the communication destination to the display device 20, communicates with the display device 20, and instructs the display device 20 to perform the video muting operation by transmitting a control command to the display device 20. Subsequently, the display device 10 switches the communication destination to the display device 30, communicates with the display device 30, and instructs the display device 30 to perform the video muting operation by transmitting a control command to the display device 30. Finally, the display device 10 needs to switch the communication destination to the display device 40, communicate with the display device 40, and instruct the display device 40 to perform the video muting operation by transmitting a control command to the display device 40. Meanwhile, each display device executes a process corresponding to the received control command at a timing when the control command is received by the display device itself. For this reason, a timing when the process corresponding to the control command is executed differs according to the display device and it is difficult to execute the processes at the same timing. In particular, if the timings of the video muting operation and the video unmuting operation deviate, there is a problem that a single display screen displayed as a multi-display becomes distorted and it is difficult to view the display screen.

As a countermeasure to this, in the present embodiment, a reference time for the timing when video control (a video muting operation, a video unmuting operation, or the like) is executed is determined in all the display devices constituting the multi-display system 1. Specifically, the master display device indicates a timing when video control is executed to each slave display device and causes each slave display device to wait so that the video control is not executed before the reference time is reached. The master display device completes communication with each slave display device by the time when the reference time is reached. When the reference time is reached, the master display device and all the slave display devices simultaneously execute video control. Thereby, the deviations in the timings of the video muting operation and the video unmuting operation are eliminated.

More specifically, the communication controller 16 of the master display device is configured to notify each slave display device of a control command including control information and additional information. The control information is information indicating the content of the video control, for example, information for issuing a video muting or unmuting instruction. The additional information is information indicating a “waiting time” before the video control is executed. When the “waiting time” is indicated in the control command, it becomes possible to align the timings of the video muting operations and the video unmuting operations in the respective display devices.

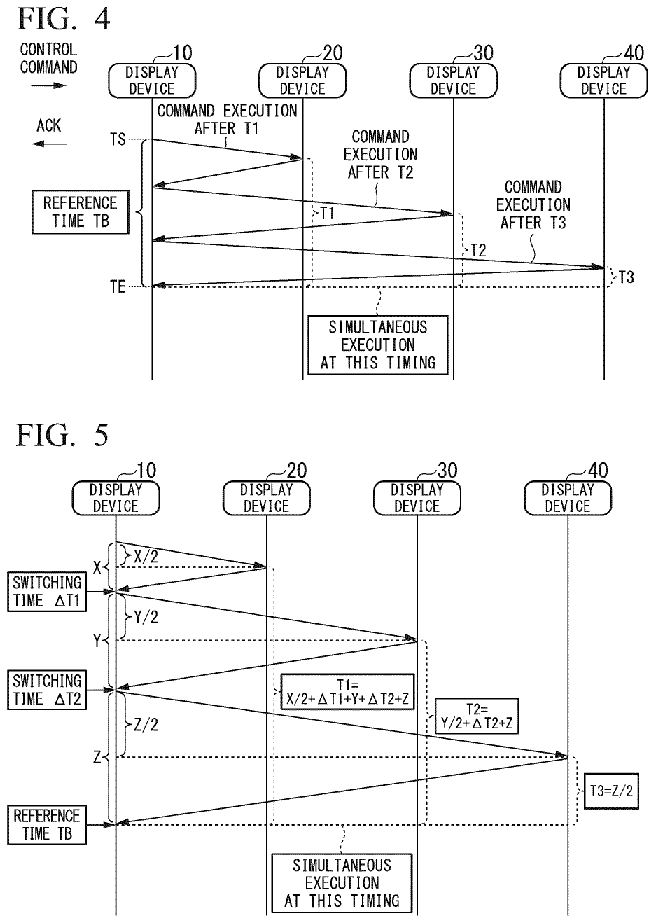

Here, the flow of the process performed by the multi-display system 1 will be described using FIGS. 4 and 5. FIGS. 4 and 5 are sequence diagrams showing the flow of the process performed by the multi-display system in the embodiment.

As shown in FIG. 4, the master display device (the display device 10) transmits a control command including delay times T (delay times T1, T2, and T3) as additional information to the respective slave display devices (the display devices 20, 30, and 40). The delay time T is an example of the “waiting time.”

The display device 10 calculates the delay time T on the basis of a reference time TB. The reference time TB is a period of time from a communication start time TS to a control execution time TE. The communication start time TS is a timing when the control command is transmitted to the first slave display device (the display device 20). The control execution time TE is a timing when an ACK is received from the last slave display device (the display device 40) in communication with the display device. At the control execution time TE, video control corresponding to the control command transmitted by the master display device to each slave display device is executed.

The display device 10 identifies the delay time T1 so that the reference time TB is reached when the delay time T1 has elapsed after the display device 20 received the control command.

The display device 10 identifies the delay time T2 so that the reference time TB is reached when the delay time T2 has elapsed after the display device 30 received the control command.

The display device 10 identifies the delay time T3 so that the reference time TB is reached when the delay time T3 has elapsed after the display device 40 received the control command.

First, the display device 10 transmits a control command including the delay time T1 as additional information to the display device 20. When the control command is received, the display device 20 executes video control when the delay time T1 has elapsed on the basis of the additional information included in the received control command.

Subsequently, the display device 10 transmits a control command including the delay time T2 as additional information to the display device 30. When the control command is received, the display device 30 executes video control when the delay time T2 has elapsed on the basis of the additional information included in the received control command.

Finally, the display device 10 transmits a control command including the delay time T3 as additional information to the display device 40. When the control command is received, the display device 40 executes video control when the delay time T3 has elapsed on the basis of the additional information included in the received control command.

The display device 10 executes the video control on its own device at a timing when the reference time TB has elapsed from the communication start time TS. For example, the display device 10 sets a delay time so that the reference time TB elapses at a timing when an ACK is received from the display device 40 and executes the video control on its own device when the ACK is received from the display device 40. Thereby, all the display devices simultaneously execute the video control at the reference time TB.

The display device 10, for example, measures in advance a response time required for calculating the reference time TB until an ACK is received from the notification of the control command for each display device. The display device 10 calculates the delay time T on the basis of the measured response time.

For example, as shown in FIG. 5, it is assumed that the time required until an ACK is received from the display device 20 after the display device 10 transmits a control command to the display device 20 is a response time X. In this case, the time required for the display device 20 to receive the control command transmitted by the display device 10 can be said to be about half (X/2) of the response time X. Therefore, the display device 10 determines the time required by the display device 20 to be X/2.

Moreover, it is assumed that the time required until an ACK is received from the display device 30 after the display device 10 transmits a control command to the display device 30 is a response time Y. In this case, the time required for the display device 30 to receive the control command transmitted by the display device 10 can be said to be about half (Y/2) of the response time Y. Therefore, the display device 10 determines the time required by the display device 30 to be Y/2.

Moreover, it is assumed that the time required until an ACK is received from the display device 40 after the display device 10 transmits a control command to the display device 40 is a response time Z. In this case, the time required for the display device 40 to receive the control command transmitted by the display device 10 can be said to be about half (Z/2) of the response time Z. Therefore, the display device 10 determines the time required by the display device 40 to be Z/2.

In this case, the display device 10 calculates the delay times T1 to T3 using the response times X to Z as follows.

$$T 1 = X / 2 + Y + Z \qquad ( 1 )$$

$$T 2 = Y / 2 + Z \qquad ( 2 )$$

$$T 3 = Z / 2 \qquad ( 3 )$$

Moreover, the time required to switch communication between the display device 10 and each slave display device (a switching time AT) is shown in FIG. 5. The display device 10 may calculate the delay time T in consideration of the switching time ΔT.

For example, it is assumed that the display device 10 requires a switching time ΔT1 to change a communication destination from the display device 20 to the display device 30. Moreover, it is assumed that the display device 10 requires a switching time ΔT2 to change the communication destination from the display device 30 to the display device 40. In this case, the display device 10 calculates delay times T1 to T3 on the basis of the response times X to Z and the switching times ΔT1 and ΔT2 as follows.

$$T 1 = X / 2 + Δ T 1 + Y + Δ T 2 + Z \qquad ( 4 )$$

$$T 2 = Y / 2 + Δ T 2 + Z \qquad ( 5 )$$

$$T 3 = Z / 2 \qquad ( 6 )$$

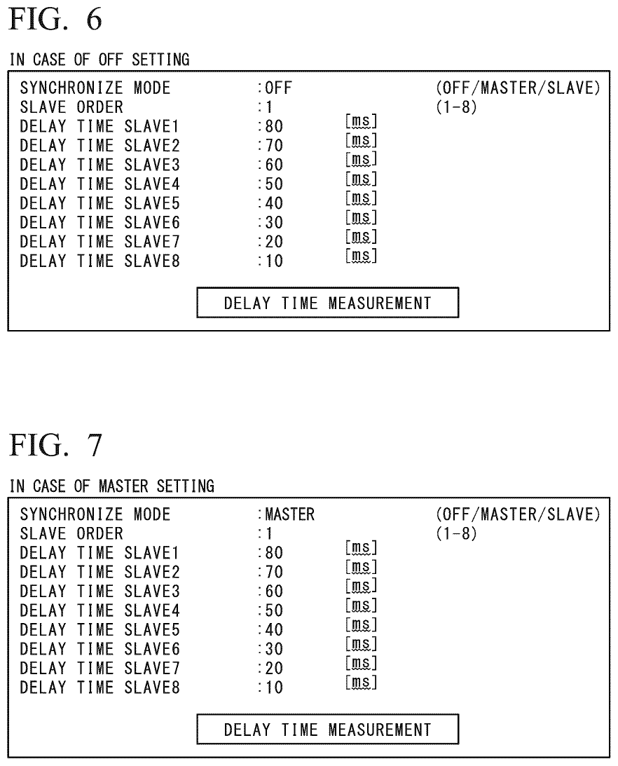

Here, the information set in each display device will be described using FIGS. 6 to 8. FIGS. 6 to 8 are diagrams showing examples of information set in the display devices in the embodiment.

As setting items set in the display devices, for example, there are a synchronization mode (SYNCHRONIZE MODE), a communication order (SLAVE ORDER), and delay times (from DELAY TIME SLAVE1 to DELAY TIME SLAVE8).

These setting items are provided, for example, in on-screen display (OSD) of the display device. The user can set these setting items by operating the OSD operation panel displayed on the monitor of the display device.

The synchronization mode (SYNCHRONIZE MODE) is an item for setting whether or not to apply the display device as a multi-display or setting whether to set the display device as a master or slave display device when the multi-display is applied. When the multi-display is not applied, (OFF) is set. When the display device is set as the master display device of the multi-display, (MASTER) is set. When the display device is set as the slave display device of the multi-display, (SLAVE) is set.

The communication order (SLAVE ORDER) is an item for setting the order in which a control command notification is provided from the master display device (any of 1 to 8 in the example in this drawing) when the display device is set as the slave display device of the multi-display.

The delay times (from DELAY TIME SLAVE1 to DELAY TIME SLAVE8) are items for setting the respective delay times of the slave display devices connected to the master display device when the display device is set as the master display device of the multi-display.

In FIG. 6, an example in which the display device is not applied as the multi-display, i.e., the synchronization mode is set to (OFF) is shown. In this case, the respective items of the communication order (SLAVE ORDER) and the delay times (from DELAY TIME SLAVE1 to DELAY TIME SLAVE8) are disabled and no information is set.

In FIG. 7, an example in which the display device is applied as the master display device of the multi-display, i.e., the synchronization mode is set to (MASTER), is shown. In this case, the communication order (SLAVE ORDER) item is disabled and no information is set. On the other hand, the delay times (from DELAY TIME SLAVE1 to DELAY TIME SLAVE8) are set to the delay times for the respective slave display devices.

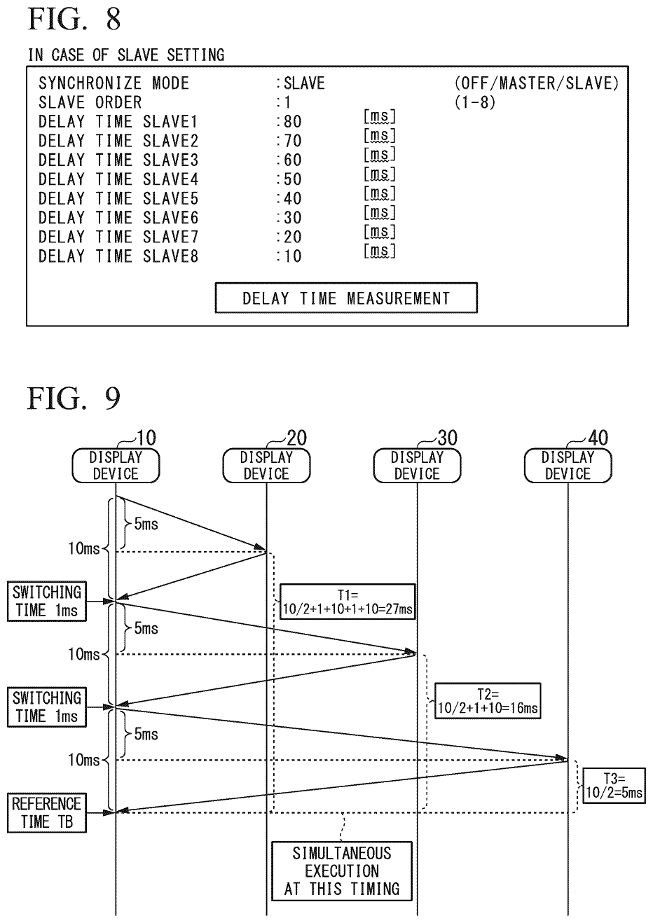

In FIG. 8, an example in which a display device is applied as a slave display device in the multi-display system, i.e., the synchronization mode is set to (SLAVE), is shown. In this case, a position of the display device in the daisy-chain connection is set in the communication order (SLAVE ORDER). On the other hand, each of the delay times (from DELAY TIME SLAVE1 to DELAY TIME SLAVE8) is invalid and no information is set.

For example, a user builds the multi-display system 1 and sets the synchronization mode to either (MASTER) or (SLAVE) for each display device. Moreover, the user sets the communication order (SLAVE ORDER) for each slave display device. After these settings are completed, the user performs an operation for selecting “DELAY TIME MEASUREMENT” in FIG. 7. Thereby, the delay time in each slave display device is measured by the master display device. Specifically, a dummy control command is transmitted from the master display device to each slave device and the delay times shown in Eqs. (1) to (3) are calculated on the basis of the response time required until the ACK is received from a notification of the control command. The master display device sets the delay time in each slave device by displaying the calculated delay time in each slave device in the delay times (from DELAY TIME SLAVE1 to DELAY TIME SLAVE8) in FIG. 7.

In addition, in this case, the master display device may be configured to calculate the delay time including the switching time AT as shown in Eqs. (4) to (6).

Also, a default value may be set in the delay time setting item. The default value is applied when no measurement is performed.

FIG. 9 is a sequence diagram showing a flow of a process performed by the multi-display system in the embodiment. In FIG. 9, an example in which the delay time is measured is shown.

In FIG. 9, an example in which response time X=10 [ms], response time Y=10 [ms], response time Z=10 [ms], switching time ΔT1=1 [ms], and switching time ΔT2=1 [ms] is shown. In this case, the display device 10 calculates the delay times T1 to T3 as follows.

$$T 1 = 10 [ ms ] / 2 + 1 [ ms ] + 10 [ ms ] + 1 [ ms ] + 10 [ ms ] = 27 [ ms ]$$

$$T 2 = 10 [ ms ] / 2 + 1 [ ms ] + 10 [ ms ] = 16 [ ms ]$$

$$T 3 = 10 [ ms ] / 2 = 5 [ ms ]$$

For example, when the user or the like operates the switch SW to switch the video input to the display device 10, the display device 10 transmits a control command for instructing the display device 20 to execute the video muting operation with additional information of delay time T1=27 [ms]. When the ACK is received from the display device 20, the display device 10 switches the communication destination to the display device 30 and transmits a control command for instructing the display device 30 to execute the video muting operation with additional information of delay time T2=16 [ms]. When the ACK is received from the display device 30, the display device 10 switches the communication destination to the display device 40 and transmits a control command for instructing the display device 40 to execute the video muting operation with additional information of delay time T3=5 [ms]. When the ACK is received from the display device 40, the display device 10 executes the video muting operation on its own device. As a result, video muting operations are executed simultaneously in the four display devices at the reference time TB.

Subsequently, each display device performs signal processing associated with the switching of the input video and can, for example, detect the state of the post-switching video, perform various settings according to the detected video state, and correctly display the post-switching video, i.e., each display device is in a state in which the video can be unmuted. The display device 10 waits until the video can be unmuted on the display devices including its own device. The display device 10 determines whether or not the video can be unmuted on each slave display device by, for example, polling each slave display device. When all the display devices including the display device 10 are in a state in which the video unmuting operations can be performed, the display device 10 sequentially transmits control commands for instructing the respective slave display devices to perform the video unmuting operations. The display device 10 transmits the control command for instructing the display device 20 to execute the video unmuting operation with additional information of delay time T1=27 [ms]. When an ACK is received from the display device 20, the display device 10 switches the communication destination to the display device 30, and transmits a control command for instructing the display device 30 to execute the video unmuting operation with additional information of delay time T2=16 [ms]. When an ACK is received from the display device 30, the display device 10 switches the communication destination to the display device 40 and transmits a control command for instructing the display device 40 to execute the video unmuting operation with additional information of delay time T3=5 [ms]. When an ACK is received from the display device 40, the display device 10 executes a video unmuting operation on its own device. Thereby, the video unmuting operations are simultaneously executed in the four display devices at the reference time TB.

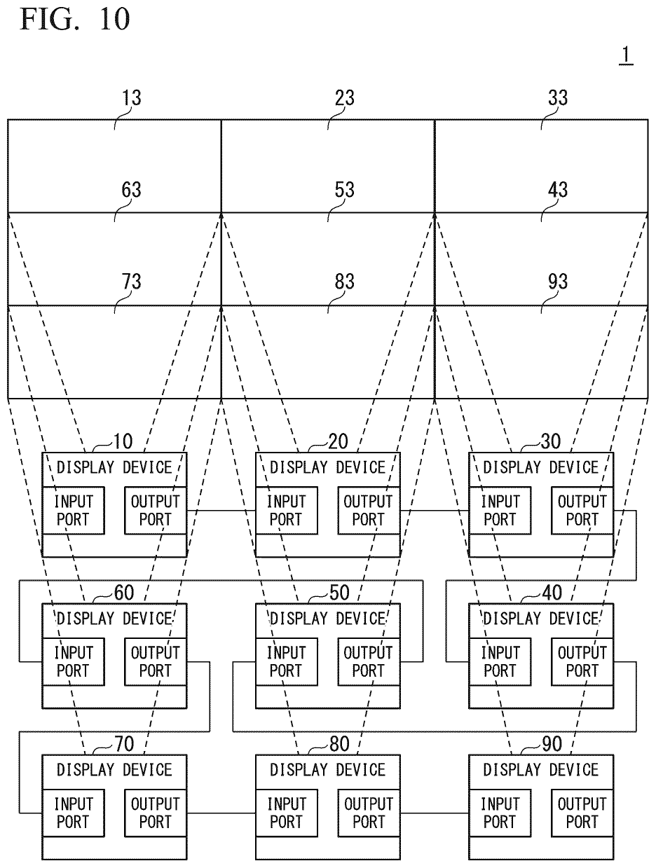

Here, an example of the application of the multi-display system 1 will be described with reference to FIGS. 10 to 12. FIGS. 10 to 12 are explanatory diagrams of a multi-display system in the embodiment.

An example in which nine display devices are connected in a daisy chain in the multi-display system 1 is shown in FIG. 10. When a large number of display devices are connected in the daisy chain in this way, a period of time required for communication from a master display device (a display device 10) to each of slave display devices (display devices 20 to 90) increases. For this reason, when the display device 10 does not include a delay time in additional information and transmits a control command to each slave display device, the deviation in a timing of video muting or unmuting becomes noticeable. In this case, the display device 10 enables all the display devices to simultaneously perform video muting or unmuting operations by including a delay time in the additional information and transmitting the control command to each display device.

In the example of FIG. 10, the nine display devices are connected in the daisy chain in the order of the display device 10, the display device 20, the display device 30, the display device 40, the display device 50, the display device 60, the display device 70, the display device 80, and the display device 90.

For example, it is assumed that the user appropriately sets respective OSD setting items shown in FIGS. 6 to 8. In the example of FIG. 10, the display device 10 is set as the master display device and each of the display devices 20 to 90 is set as the slave display device.

Moreover, in the display device 10, it is assumed that a setting process of executing communication with the display device 10 in the order of the display device 90, the display device 80, the display device 70, the display device 60, the display device 50, the display device 40, the display device 30, and the display device 20 as the communication order (SLAVE ORDER) of the slave display devices has been performed. In this way, the communication order may be set regardless of the order of the daisy chain connection.

After these settings are completed, the user performs an operation for selecting “DELAY TIME MEASUREMENT” in FIG. 7. Thereby, the master display device measures the delay time in each slave display device.

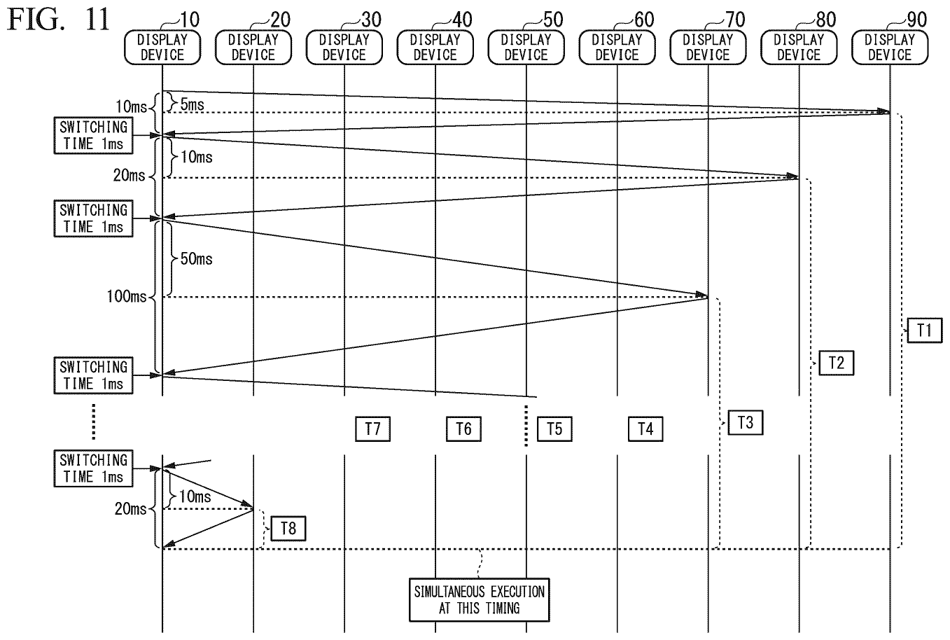

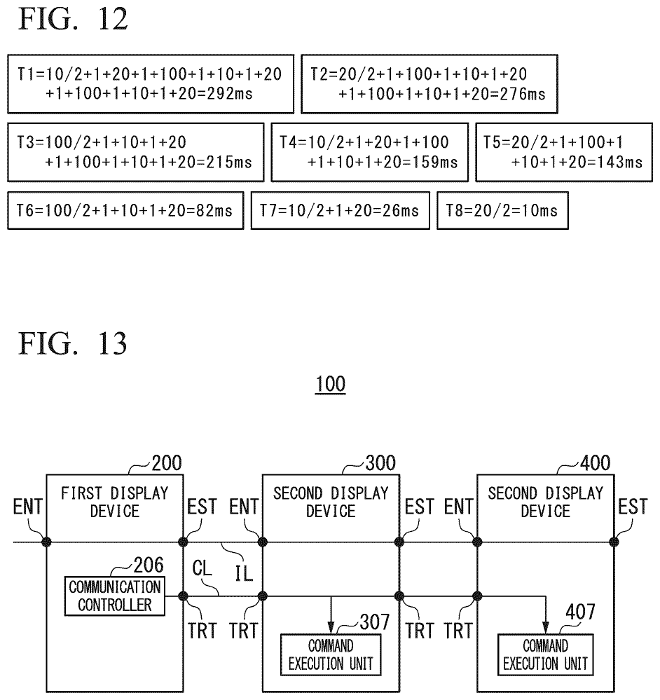

Results of measuring delay times are shown in FIGS. 11 and 12. In the examples shown in FIGS. 11 and 12, delay time T1 is the delay time in the display device 90. Delay time T2 is the delay time in the display device 80. Subsequently, likewise, delay time T8 is the delay time in the display device 20.

For example, it is assumed that the response times required for communication with each slave device are measured as follows:
Response time with SLAVE1 (display device 90)=10 [ms]
Response time with SLAVE2 (display device 80)=20 [ms]
Response time with SLAVE3 (display device 70)=100 [ms]
Response time with SLAVE4 (display device 60)=10 [ms]
Response time with SLAVE5 (display device 50)=20 [ms]
Response time with SLAVE6 (display device 40)=100 [ms]
Response time with SLAVE7 (display device 30)=10 [ms]
Response time with SLAVE8 (display device 20)=20 [ms]

Moreover, the switching time AT is assumed to be 1 [ms], regardless of the slave display device that is a switching destination. In this case, as shown in FIG. 12, the delay times are as follows.
T1 (delay time in display device 90)=292 [ms]
T2 (delay time in display device 80)=276 [ms]
T3 (delay time in display device 70)=215 [ms]
T4 (delay time in display device 60)=159 [ms]
T5 (delay time in display device 50)=143 [ms]
T6 (delay time in display device 40)=82 [ms]
T7 (delay time in display device 30)=26 [ms]
T8 (delay time in display device 20)=10 [ms]

For example, when the user or the like operates the switch SW and the video input to the display device 10 is switched, the display device 10 transmits a control command for instructing the display device 90 to execute a video muting operation with additional information of delay time T1=292 [ms]. When an ACK is received from the display device 90, the display device 10 switches the communication destination to the display device 80 and transmits a control command for instructing the display device 80 to execute a video muting operation with additional information of delay time T2=276 [ms]. Subsequently, likewise, the display device 10 transmits a control command to the display device 70 with additional information of delay time T3=215 [ms]. The display device 10 transmits a control command to the display device 60 with additional information of delay time T4=159 [ms]. The display device 10 transmits a control command to the display device 50 with additional information of delay time T5=143 [ms]. The display device 10 transmits a control command to the display device 40 with additional information of delay time T6-82 [ms]. The display device 10 transmits a control command to the display device 30 with additional information of delay time T7-26 [ms]. The display device 10 transmits a control command to the display device 20 with additional information of delay time T8=10 [ms]. When an ACK is received from the display device 20, the display device 10 executes a video muting operation on its own device. Thereby, video muting operations are executed simultaneously on the nine display devices at the reference time TB.

Subsequently, when all display devices including the display device 10 are in a state in which the video unmuting operation can be performed, the display device 10 sequentially transmits control commands for instructing the respective slave display devices to perform the video unmuting operations. The display device 10 transmits the control command for instructing the display device 90 to execute the video unmuting operation with additional information of delay time T1=292 [ms]. When an ACK is received from the display device 90, the display device 10 switches the communication destination to the display device 80 and transmits a control command for instructing the display device 80 to execute the video unmuting operation with additional information of delay time T2=276 [ms]. Subsequently, the same is true for the rest. When an ACK is received from the display device 20, the display device 10 executes the video unmuting operation on its own device. Thereby, the video unmuting operations are simultaneously executed in the nine display devices at the reference time TB.

As described above, the display device 10 of the embodiment includes a video input terminal ENT, a video output terminal EST, a communication terminal TRT, and a communication controller 16. The video input terminal ENT inputs a video signal. The video output terminal EST outputs the video signal input to the video input terminal ENT. The communication terminal TRT performs one-to-one communication with each of the slave display devices (the plurality of display devices). The communication controller 16 notifies each of the slave display devices of a control command by switching the destination of communication via the communication terminal TRT. The control command includes control information and additional information. The control information is information for instructing the communication destination display device to execute video control, for example, such as a video muting operation and a video unmuting operation (a specific process). The additional information is information indicating the delay time (a waiting time before a process corresponding to the control information is executed).

Thereby, the display device 10 of the embodiment can indicate a timing when video control is executed to the other display devices. Therefore, in a multi-display system in which display devices transmit and receive control signals on a one-to-one basis, timings when the respective display devices execute control can be synchronized with each other.

Moreover, in the display device 10 of the embodiment, the communication controller 16 calculates the delay times on the basis of the response times X to Z (communication times). The response times X to Z are the times required for communication with the respective slave display devices via the communication terminal TRT. The display device 10 sets half of the response time as the time required until a control command is received by a display device that is a notification destination after a notification of the control command. The display device 10 sets a sum (X/2+Y+Z) of the time required in a specific slave display device (e.g., the display device 20) and the response times of other slave display devices (e.g., the display device 30 and the display device 40) communicating with the specific slave display device after communication with the specific slave display device as the delay time (T1) in the specific slave display device (the display device 20). Thereby, the display device 10 of the embodiment can calculate the delay time on the basis of the response times required for the display devices to transmit and receive control signals on a one-to-one basis. Therefore, the timings when the respective display devices execute control can be synchronized with each other in consideration of the response times of the respective display devices.

Moreover, in the display device 10 of the embodiment, the communication controller 16 calculates the delay time on the basis of the response times X to Z (communication times) and a switching time AT. The switching time AT is the time required for the display device to switch a destination of communication via the communication terminal TRT. Thereby, in the display device 10 of the embodiment, the master display device can cause the timings when the respective display devices execute control to be synchronized with each other in consideration of the time required to switch the communication destination to each of the slave display devices.

Moreover, in the display device 10 of the embodiment, when the video signal input to the video input terminal ENT is switched, the communication controller 16 notifies each of the slave display devices of a control command for issuing a video muting instruction. Thereby, when the video signal is switched, the video muting operations can be simultaneously performed in all the display devices.

Moreover, in the display device 10 of the embodiment, the communication controller 16 notifies each slave display device of a control command for issuing a video unmuting instruction after a state in which the video signal input to the video input terminal ENT is switched and a post-switching video can be displayed correctly on each slave display device (a state in which a switching condition for switching a video signal is satisfied) is reached. Thereby, the video unmuting operations can be performed after the post-switching video can be displayed correctly on all the display devices after the video signal is switched.

The multi-display system 1 of the embodiment includes a display device 10 (a first display device), a display device 20, and a display device 30 (a plurality of second display devices). The display device 10 includes a video input terminal ENT, a video output terminal EST, a communication terminal TRT, and a communication controller 16. The communication controller 16 notifies each of the display devices 20 and 30 of a control command by switching a destination of communication via the communication terminal TRT. The display device 20 includes a video input terminal ENT, a video output terminal EST, a communication terminal TRT, and a command execution unit 27. The command execution unit 27 executes a process corresponding to the control information of the control command when a waiting time indicated in the additional information of the control command has elapsed on the basis of the control command received via the communication terminal TRT. The display device 30 includes a video input terminal ENT, a video output terminal EST, a communication terminal TRT, and a command execution unit 37. The command execution unit 37 executes a process corresponding to the control information of the control command when the waiting time indicated in the additional information of the control command has elapsed on the basis of the control command received via the communication terminal TRT. Thereby, a similar effect as that described above is obtained in the multi-display system 1 of the embodiment.

The communication controller 16 notifies the display device 20 of a control command in which delay time T1 is designated and notifies the display device 30 of a control command in which delay time T2 is designated after an ACK is received from the display device 20. Here, as shown in Eqs. (1) to (3), a difference between delay times T1 and T2 is a sum of time (X/2) required from the time when the display device 20 transmits an ACK to the display device 10 to the time when the display device 10 receives the ACK and time (Y/2) required from the time when the display device 10 transmits a control command to the display device 30 to the time when the display device 30 receives the control command. In other words, (T1−T2)=(X/2+Y/2).

Here, a basic configuration of the multi-display system will be described using FIG. 13. FIG. 13 is a block diagram showing the basic configuration of the multi-display system 100 in the embodiment. The multi-display system 100 includes a first display device 200 (a first display device), and a plurality of second display devices 300 and 400 as the basic configuration. The first display device 200 basically includes a video input terminal ENT, a video output terminal EST, a communication terminal TRT, and a communication controller 206. The video input terminal ENT inputs a video signal. The video output terminal EST outputs the video signal input to the video input terminal ENT. The communication terminal TRT performs one-to-one communication with each of the second display device 300 and the second display device 400. The communication controller 206 notifies each of the second display device 300 and the second display device 400 of a control command by switching the destination of communication via the communication terminal TRT. The second display device 300 includes a video input terminal ENT, a video output terminal EST, a communication terminal TRT, and a command execution unit 307. The command execution unit 307 executes a process corresponding to the control information of the control command at the execution timing indicated in the additional information of the control command on the basis of the control command received via the communication terminal TRT. The second display device 400 includes a video input terminal ENT, a video output terminal EST, a communication terminal TRT, and a command execution unit 407. On the basis of the control command received via the communication terminal TRT, the command execution unit 407 executes a process corresponding to the control information of the control command at the execution timing indicated in the additional information of the control command.

Moreover, a program for implementing functions of the multi-display system 1 in FIG. 1 is recorded on a computer-readable recording medium, and the program recorded on the recording medium may be read into a computer system and executed to perform a position detection process. In addition, the “computer system” used here is assumed to include an operating system (OS) or hardware such as peripheral devices.

Moreover, the “computer system” is assumed to include a homepage provision environment (or display environment) if a World Wide Web (WWW) system is used. Moreover, the “computer-readable recording medium” refers to a flexible disk, a magneto-optical disc, a read-only memory (ROM), a portable medium such as a compact disc-ROM (CD-ROM), or a storage device such as a hard disk embedded in the computer system. Furthermore, the “computer-readable recording medium” is assumed to include a medium that holds a program for a certain period of time, such as a volatile memory inside a computer system serving as a server or a client. Moreover, the above-described program may be a program for implementing some of the above-described functions. Further, the above-described function may be implemented in combination with a program already recorded on the computer system. Moreover, the above-described program may be stored in a predetermined server and the program may be distributed (downloaded or the like) via a communication circuit in response to a request from another device.

Although embodiments of the present invention have been described in detail above with reference to the drawings, specific configurations are not limited to the embodiments and other designs and the like may also be included without departing from the scope and spirit of the present invention.

### REFERENCE SIGNS LIST

1 Multi-display system
10, 20, 30, 40, 50, 60, 70, 80, 90 Display device
11, 21, 31, 41, 51, 61, 71, 81, 91 Input port
12, 22, 32, 42, 52, 62, 72, 82, 92 Output port
T1, T2, T3, T4, T5, T6, T7, T8, T9 Delay time
TRT Communication terminal
ENT Video input terminal
EST Video output terminal

What is claimed is:

1. A display device comprising:
a video input terminal configured to input a video signal;
a video output terminal configured to output the video signal input;
a communication terminal configured to perform one-to-one communication with each of a plurality of display devices; and
a communication controller configured to notify each of the plurality of display devices of a control command including control information for issuing an instruction to execute a specific process by switching a destination of communication via the communication terminal and additional information indicating a waiting time before a process corresponding to the control information is executed.

2. The display device according to claim 1, wherein the communication controller is configured to calculate the waiting time for each of the plurality of display devices on the basis of a communication time required for communication with each of the plurality of display devices via the communication terminal.

3. The display device according to claim 2, wherein the communication controller is configured to calculate the waiting time for each of the plurality of display devices on the basis of the communication time and a switching time required for a process of switching the destination of the communication via the communication terminal.

4. The display device according to claim 1, wherein the communication controller is configured to notify each of the plurality of display devices of the control command including the control information for instructing the display device to perform a video muting operation when the video signal input to the video input terminal is switched.

5. The display device according to claim 4, wherein the communication controller is configured to notify each of the plurality of display devices of the control command including the control information for instructing the display device to perform a video unmuting operation after the video signal input to the video input terminal is switched and a switching condition for switching the video signal is satisfied in each of the plurality of display devices.

6. A multi-display system comprising a first display device and a plurality of second display devices,
wherein the first display device comprises:
a video input terminal configured to input a video signal;
a video output terminal configured to output the video signal input;
a communication terminal configured to perform one-to-one communication with each of the plurality of second display devices; and
a communication controller configured to notify each of the plurality of second display devices of a control command including control information for issuing an instruction to execute a specific process by switching a destination of communication via the communication terminal and additional information indicating a waiting time before a process corresponding to the control information is executed, and
wherein each of the plurality of second display devices comprises:
a video input terminal configured to input a video signal;
a video output terminal configured to output the video signal input to the video input terminal;
a communication terminal configured to perform one-to-one communication with the first display device; and
a command execution controller configured to execute a process corresponding to the control information in the control command when the waiting time indicated in the additional information in the control command has elapsed on the basis of the control command received via the communication terminal.

7. A display control method, performed by a display device comprising a video input terminal configured to input a video signal, a video output terminal configured to output the video signal input to the video input terminal, and a communication terminal configured to perform one-to-one communication with each of a plurality of display devices, the display control method comprising:
notifying, by a communication controller, each of the plurality of display devices of a control command including control information for issuing an instruction to execute a specific process by switching a destination of communication via the communication terminal and additional information indicating a waiting time before a process corresponding to the control information is executed.
